(19) United States
(12) Patent Application Publication
(10) Pub. No.: US 2022/0138504 A1
(43) Pub. Date: May 5, 2022

(54) SEPARATION MAXIMIZATION TECHNIQUE FOR ANOMALY SCORES TO COMPARE ANOMALY DETECTION MODELS

(71) Applicant: Oracle International Corporation, Redwood Shores, CA (US)

(72) Inventors: Hesam Fathi Moghadam, Sunnyvale, CA (US); Anatoly Yakovlev, Hayward, CA (US); Sandeep Agrawal, San Jose, CA (US); Venkatanathan Varadarajan, Seattle, WA (US); Robert Hopkins, Foster City, CA (US); Matteo Casserini, Zurich (CH); Milos Vasic, Zurich (CH); Sanjay Jinturkar, Santa Clara, CA (US); Nipun Agarwal, Saratoga, CA (US)

(21) Appl. No.: 17/083,536

(22) Filed: Oct. 29, 2020

(51) Int. Cl. G06K 9/62; G06N 20/20

(52) U.S. Cl. CPC G06K 9/6262; G06K 9/6218; G06N 20/20; G06K 9/6215; G06K 9/623

(57) ABSTRACT

In an embodiment based on computer(s), an ML model is trained to detect outliers. The ML model calculates anomaly scores that include a respective anomaly score for each item in a validation dataset. The anomaly scores are automatically organized by sorting and/or clustering. Based on the organized anomaly scores, a separation is measured that indicates fitness of the ML model. In an embodiment, a computer performs two-clustering of anomaly scores into a first organization that consists of a first normal cluster of anomaly scores and a first anomaly cluster of anomaly scores. The computer performs three-clustering of the same anomaly scores into a second organization that consists of a second normal cluster of anomaly scores, a second anomaly cluster of anomaly scores, and a middle cluster of anomaly scores. A distribution difference between the first organization and the second organization is measured. An ML model is processed based on the distribution difference.

### FIELD OF THE INVENTION

The present invention relates to probabilistic anomaly detection. Herein are statistical measurements of goodness of fit for validation of unsupervised training of a machine learning (ML) model.

### BACKGROUND

Identification of abnormal instances in a dataset is typically referred to as anomaly detection. Anomaly detection is an important tool with various use cases in security such as fraud detection and intrusion detection. A large variety of machine learning (ML) algorithms detect anomalies in various complex ways. Some examples are nearest neighbor, clustering, and subspace. These algorithms are all different, but what they have in common is that they all, internally, use a decision function that produces scores, called anomaly scores, which are respectively generated by the algorithm for each item in a dataset. The higher the anomaly score, the higher the likelihood that the item is anomalous.

Machine learning has various kinds of training, including supervised training and unsupervised training. Supervised training uses items that are already known as anomalous or normal. That is, supervised training items are each already labeled as anomalous or normal. However, such labeling is usually very expensive to do as a prerequisite of supervised training. Unsupervised training does not use labels and avoids that expense.

Goodness of fit, known herein as fitness, is a metric that indicates how accurate is a statistical model, a regression model or, especially herein, an ML model and how ready is the ML model for use in a production environment. For example, a trained ML model should have a higher fitness than an untrained ML model. ML model fitness may be measured in various known ways.

If labeled training items are available, known scoring metrics such as area under receiver operating curve (ROC_AUC), recall, and precision can be used to compare the relative fitness of different anomaly detection models. However, a problem arises when labeled data does not exist, for example in an unsupervised setting. Scoring metrics that work well without labeled data, across a wide variety of datasets and machine learning algorithms, were more or less unknown. Hand labeling the data is one solution, as it removes the need for unsupervised learning. However, this is very time consuming and typically requires domain experts to analyze individual samples.

### BRIEF DESCRIPTION OF THE DRAWINGS

In the drawings:

FIG. 1 is a block diagram that depicts an example computer that, based on probabilities or other statistics, validates fitness of machine learning (ML) models for binary classification such as outlier detection, during or after unsupervised training;

FIG. 2 is a flow diagram that depicts an example computer process that, based on probabilities or other statistics, validates fitness of ML models for binary classification such as outlier detection, during or after unsupervised training;

FIG. 3 is a flow diagram that depicts example computer activities for measuring, based on probabilities or other statistics, fitness of ML models for binary classification such as outlier detection, during or after unsupervised training;

FIG. 4 is a block diagram that depicts an example computer that, based on statistical clustering, analyzes validation results of ML models for binary classification such as outlier detection, during or after unsupervised training;

FIG. 5 is a flow diagram that depicts example computer activities for measuring, based on clustering, fitness of ML models for binary classification such as outlier detection;

FIG. 6 is a flow diagram that depicts example computer activities for, based on three-clustering, calculating a fitness metric of ML models for binary classification such as outlier detection, during or after unsupervised training;

FIG. 7 is a block diagram that illustrates a computer system upon which an embodiment of the invention may be implemented;

FIG. 8 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Herein are machine learning (ML) model fitness metrics, such as separation, that do not need training labels and can be used for unsupervised training. For example, measured separation can be used to compare relative fitness of ML models or for early stopping during training. As presented herein, measured separation is well suited for anomaly detection tasks, which entails separating normal and anomalous data, without requiring labels for the data.

In some embodiments that distinguishes anomalous items from normal items, a separation metric is based on a contamination factor that is a predefined percentage of anomalous data in a dataset. Because measured separation is well suited for comparing model performance characteristics, separation can be used for model optimization or for early stopping of training to prevent model overfitting.

An embodiment sorts anomaly scores provided by an anomaly detection algorithm, where high scores correspond to anomalies and low scores correspond to normal data. After sorting, the contamination factor is used to divide the anomaly scores into two separate subsets. Herein, a goal is to provide a metric that is indicative of the separation between those two subsets. In general, the greater the separation, the better an ML model is at distinguishing between the anomalous and normal data.

Fitness metrics herein are generally applicable to any class of anomaly or outlier detection algorithm and do not rely on properties of the algorithm such as reconstruction error or cluster density. Because approaches herein do not require labeled training data, these approaches are applicable to weak-supervised, semi-supervised, and unsupervised training for anomaly or outlier detection. With semi-supervision, only a subset of the training items are labeled. With weak supervision, all training items are unreliably labeled such as previously by a trained different ML model that sometimes makes mistakes.

Early stopping is commonly used to prevent models from overfitting. Because labeled training data is seldom available for anomaly detection use cases, early stopping of unsupervised training is impossible with other fitness metrics such as reconstruction error. Fitness and separation metrics herein can be used to perform early stopping, which accelerates training such that training consumes less energy.

In any case, a goal of fitness metrics herein is to maximize a summary of the scores of the anomalies relative to a summary of the scores of the normal data, i.e., maximize the separation between the anomalous and normal data. An additional goal is to maximize the separation between the normal and anomalous data points. This includes maximization of separation of the closest points between each class. The higher the score, the more likely the model did well at separating the anomalous from the normal data.

Herein is an additional unsupervised fitness metric technique based on clustering that do not need classification labels for training data. The clustering technique does not rely on contamination factor (percentage of anomalous data in the dataset) to separate the two classes of items. For example, a contamination factor may optionally be calculated after computing the clustering-based metric. Measuring a contamination factor of a dataset without labels is novel.

Anomaly scores are organized into two clusters using any clustering method, such as K-Means, and a center of each cluster is calculated in any of various ways such as average anomaly score within each cluster. The cluster that has a smaller center value contains the normal set of items. The other cluster, contains the anomalous set of items.

Any internal clustering validation measure, such as one based on cluster separation and/or compactness, may be used to compute a fitness metric that can be used to compare different models. In an extreme case, where the ML model perfectly identifies normal and anomalous cases, the cluster centers would respectively be at zero and one, where maximum separation is achieved.

ML model performance metrics herein improve ML model performance by avoiding wasteful training and deployment of inferior ML models. Many ML models may be ranked by measured separation between normals and anomalies to facilitate automatic selection of a best one or few ML models for promotion as described herein such as for: a) prolonged retraining with a much bigger training corpus, b) exploratory retrainings with experimental hyperparameters settings, and/or c) deployment into a production environment. Avoiding wasteful training and deployment saves time and energy and facilitates dedication of expensive computer resources to maximizing the preparation of best ML model(s).

In an embodiment based on one or more computers, an ML model is trained to detect outliers. The ML model calculates unorganized anomaly scores that include a respective anomaly score for each item in a validation dataset. The unorganized anomaly scores are automatically organized, such as by sorting and/or clustering, as organized anomaly scores. Based on the organized anomaly scores, a separation is measured that indicates fitness of the ML model.

Another technique provides further adjustment of the clustering-based fitness metric as follows. In an embodiment, a computer performs two-clustering of anomaly scores into a first organization that consists of a first normal cluster of anomaly scores and a first anomaly cluster of anomaly scores. The computer performs three-clustering of the same anomaly scores into a second organization that consists of a second normal cluster of anomaly scores, a second anomaly cluster of anomaly scores, and a middle cluster of anomaly scores. A distribution difference between the first organization and the second organization is measured such as cross entropy as explained herein. An ML model is processed based on the distribution difference.

### 1.0 Example Computer

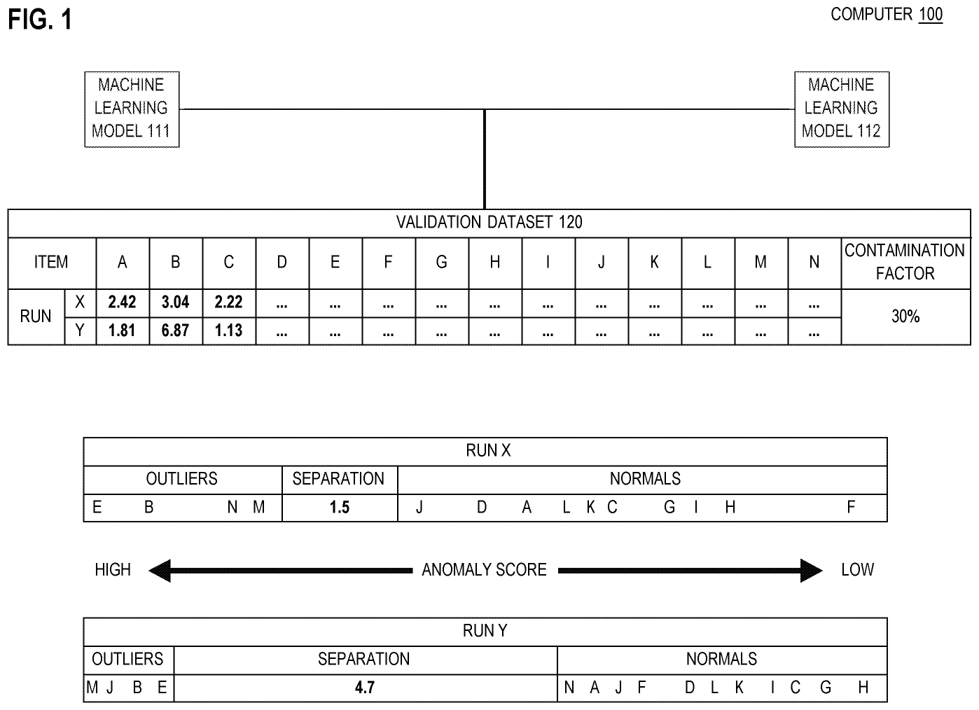

FIG. 1 is a block diagram that depicts an example computer 100, in an embodiment. Based on probabilities or other statistics, computer 100 validates fitness of machine learning (ML) models such as 111-112 for binary classification such as outlier detection, during or after unsupervised training. Computer 100 may be one or more of a rack server such as a blade, a personal computer, a mainframe, a virtual computer, or other computing device.

In various embodiments and in various ways, computer 100 manages one or multiple ML models such as 111-112 that were already trained by computer 100 or another computer and may be currently hosted on computer 100, another computer, or no computer. In other words, the techniques herein for computer 100 do not need to access ML models 111-112.

ML models 111-112 may have different architectures or have a same architecture but different hyperparameters. Hyperparameters are configuration settings that were set before training ML models 111-112. Hyperparameters and ML model architectures are discussed later herein.

Although computer 100 need not access already-trained ML models 111-112, computer 100 analyzes validation dataset 120 that contains quantitative results from validation of an ML model such as 111-112. The lifecycle of ML models 111-112 may be a more or less linear progression of phases from training to validation to inferencing with recent data from a production environment.

### 1.1 Validation Runs

In a software development lifecycle (SDLC), validation entails unit testing ML model 111 and/or 112 with a small amount of realistic data that is representative of the scope of variations that could occur in a production environment. In other words, validation results should estimate how an ML model would perform in production. For example, model validation may be based on validation dataset 120 that contains items A-N.

During validation, ML model 111 may be applied to each of items A-N to generate respective inferences such as anomaly scores. ML model 111 generates a numeric anomaly score that quantifies how anomalous is an item relative to typical items that ML model 111 had trained with. In an embodiment not shown, the anomaly score is unit normalized to be a real number between zero and one, with zero indicating a completely normal item, and one indicating a completely abnormal item. In an embodiment, the number between zero and one is a statistical probability that the item is anomalous. Herein, abnormal, anomalous, and outlier may be synonyms.

Whether normalized or not, a higher anomaly score indicates a more abnormal input. For example, validation dataset 120 is shown in tabular form and, during validation run X, the anomaly score of item B is 3.04 that is higher than the anomaly score of item A that is 2.42. Thus, item B is more likely to be anomalous than item A, although both or neither might actually be anomalous. The ellipses shown for items D-N indicate that items D-N also have anomaly scores but that actual scores are unshown.

Because a higher anomaly score indicates a more abnormal input, anomaly scores from a same validation run may be sorted. Below the tabular representation of validation dataset 120 is a tabular representation of validation run X. For demonstration, the items A-N are shown, in the tabular representation of run X, sorted and spaced according to the anomaly scores of items A-N. That is, the anomaly scores are sorted from highest score on the left to lowest score on the right. For example, the leftmost item is E, which means that item E has the highest anomaly score in run X, and item E is the most anomalous item in run X.

Within the tabular representation of run X, spacing between items A-N is proportional to the anomaly scores. For example, items C and K-L are shown near each other because their anomaly scores are similar. Likewise, items H and F are shown far from each other because their anomaly scores are dissimilar.

### 1.2 Classification and Labels

In ways discussed later herein, sorted anomaly scores may provide a foundation for various statistical analyses that may help ML models 111-112 detect outliers. An outlier is an abnormal item such as an anomaly. Although generally complementary to ML model training of any kind, statistical analyses herein are especially beneficial to unsupervised or incompletely supervised training as discussed later herein.

Supervised training entails computer 100 knowing in advance what are correct respective inferences for all items in a training corpus. For example, a training corpus may consist of webpages, and ML model 111 may infer which foreign language, such as English or Danish, is the content of a webpage. With supervised training, computer 100 has a predefined mapping of webpages to languages.

For example, each webpage may be labeled, such as in webpage metadata, as to which foreign language does the webpage use. The primary advantage of supervised training is that computer 100 may detect whether an inference by ML model 111 is right or wrong. With foreign languages, there may be dozens of different label values. Detection of anomalies or other outliers entails binary classification, which entails only two labels such as normal and outlier. A normal anomaly score and a normalized anomaly score are not necessarily the same. Here, normal means not anomalous. Whereas normalized means scaled to a fixed range such as zero to one such as a probability.

Unsupervised training uses a training corpus that lacks labels such that computer 100 has no predefined mapping of training items to labels. For example if ML model 111 is used for binary classification to detect suspicious network packets, computer 100 does not know in advance which network packets in the training corpus are normal and which are suspicious.

Whether supervised training or not, binary classification may entail thresholding. For example as shown for run X in the tabular representation of validation dataset 120, ML model 111 infers numeric anomaly scores instead of actually performing binary classification. Anomaly detection would need translation of anomaly scores to binary class labels such as normal and outlier, which is an additional step that ML model 111 or computer 100 may perform.

For example, an anomaly threshold may be 2.8, and any item with an anomaly score above that threshold may be classified as anomalous. Another problem with unsupervised training is that the anomaly threshold may be unknown. Techniques herein may use the value distribution of the sorted anomaly scores of run X to distinguish outliers from normals, which may facilitate a broad range of important machine learning activities such as setting an anomaly threshold and/or ranking the fitness of ML models 111-112.

### 1.3 Use Cases for Organizing Anomaly Scores

Although practical use cases are elaborated later herein, the following example use cases demonstrate additional features of FIG. 1. As shown in the tabular representation of validation dataset 120, there may be multiple validation runs X-Y over same validation dataset 120. The origin of runs X-Y depend on the use case as follows.

In one example, runs X-Y are respectively performed by separate ML models 111-112. Even though same validation dataset 120 is used to validate both of ML models 111-112, because ML models 111-112 are different, they generate different anomaly scores for each item. For example as shown in run X, ML model 111 infers an anomaly score of 2.42 for item A. Whereas in run Y, different ML model 112 infers a different anomaly score of 1.81 for same item A.

Consequences of different anomaly scores for runs X-Y are as follows. The sorted ordering of anomaly scores for same items A-N may differ between runs X-Y. For example as the separate tabular representation of run X shows, run X inferred that item E has the highest anomaly score. Whereas the separate tabular representation of run Y shows run Y instead inferred that item M has the highest anomaly score.

Likewise, different anomaly scores for runs X-Y may cause different linear spacing between anomaly scores. For example, the separate tabular representation of run X shows items M-N near each other, which means that items M-N have similar anomaly scores in run X. Whereas the separate tabular representation of run Y shows items M-N far from each other, which means that items M-N have dissimilar anomaly scores in run Y.

As elaborated later herein, various embodiments have various ways of analyzing the distribution of anomaly scores of a validation run on unlabeled items A-N to decide which items are normal and which items are outliers. In an embodiment, a predefined contamination factor of validation dataset 120 is used to separate outliers from normals as follows. As shown, the contamination factor of validation dataset 120 is thirty percent, which means that an estimated thirty percent of items A-N are outliers.

Items A-N are fourteen items. Thirty percent of fourteen items is approximately four items, which means that four of items A-N are expected to be outliers, although which four items is unknown. Thus, only the amount of outliers is initially known.

However, items A-N are sorted by anomaly score in the separate tabular representations of runs X-Y, and outliers are expected to have higher anomaly scores than the normals. Thus, the leftmost four items respectively in each of the separate tabular representations of runs X-Y may be classified as outliers, even when items A-N are unlabeled and no anomaly threshold is known. For example as shown in the separate tabular representation of run X, items B, E, and M-N are outliers. Whereas the separate tabular representation of run Y shows instead that items B, E, J, and M are outliers.

With linear sorting of anomaly scores as shown in the separate tabular representations of runs X-Y, there may be a gap of space between the group of outliers and the group of normals. For example as shown in the separate tabular representation of run X, the separation between outliers and normals is 1.5. Whereas the separate tabular representation of run Y shows a separation of 4.7.

In other words during validation run Y, ML model 112 achieved a larger separation between normals and outliers than ML model 111 achieved in run X with same validation dataset 120. Greater separation between normals and outliers indicates increased model fitness. Thus after training and validation of both ML models 111-112, computer 100 can readily detect that ML model 112 is more accurate than ML model 111.

For example as shown in the separate tabular representation of run X, items M-N are just barely within the outliers, and there is little separation between outliers and normals. Thus, either item M or N is somewhat likely to have an inaccurate anomaly score in run X. Whereas outliers and normals are greatly separated as shown in the separate tabular representation of run Y, and item N is instead classified as normal. In that way, computer 100 may readily detect that ML model 111 misclassified item N in run X as a false positive. For example, less accurate ML model 111 may be more likely to raise false alarms in a production environment than more accurate ML model 112.

In one scenario, ML models 111-112 were identical before training but, due to different training corpuses or different training durations or different learning rates, ML models 111-112 diverged before validation. In another scenario, ML models 111-112 have a same architecture but different hyperparameter configuration values. For example, ML models 111-112 may be similar artificial neural networks (ANNs) with different amounts of neural layers or different amounts of neurons per layer or different neural activation functions.

In another scenario, ML models 111-112 have discrepant architectures. For example, ML model 111 may be a neural network, and ML model 112 may instead be a principal component analysis (PCA) as discussed later herein. In any case, many ML models may be ranked by measured separation between normals and outliers such that computer 100 may select a best one or few ML models for promotion such as for: a) prolonged retraining with a much bigger training corpus, b) exploratory retrainings with experimental hyperparameters settings, and/or c) deployment into a production environment.

In a very different use case, there is only single ML model 111 that performs all validation runs X-Y. In this use case, the development lifecycle of ML model 111 is iterative instead of linear. That is, ML model 111 switches back and forth between continued training and unsuccessful validation until validation finally succeeds as follows.

Training may proceed in batches that contain random subsets of items of a training corpus. After training with each one batch, such as by feed forward and backpropagation as discussed later herein, validation of ML model 111 occurs. The more batches were used for training so far, the more accurate is ML model 111.

Thus after each of the first few training batches: a) ML model 111 has poor accuracy, b) validation of ML model 111 infers inaccurate anomaly scores, and c) ML model 111 is unable to clearly distinguish normals from outliers, such that d) there is little separation between outliers and normals. An embodiment may have a threshold amount of separation between outliers and normals should exceed to pass validation.

Thus initially, ML model 111 may repeatedly train and fail validation. However: a) accuracy of ML model 111 should somewhat monotonically increase with each training batch such that b) ML model 111 gets progressively better at distinguishing outliers from normals, which causes c) separation between outliers and normals to grow until d) the separation exceeds the threshold, and e) validation succeeds, in which case, f) training may cease.

For example, the separate tabular representations of run Y after run X show that separation increased. For example, runs X-Y may respectively fail and succeed validation. For example, successful validation run Y may cause training to cease.

Regardless of use case, various embodiments may have various ways of measuring separation between normals and outliers. That is, measurement of separation may entail calculations of various complexity. Later herein are various mathematical formulae for calculating separation in special ways.

### 2.0 Anomaly Score Organization Process

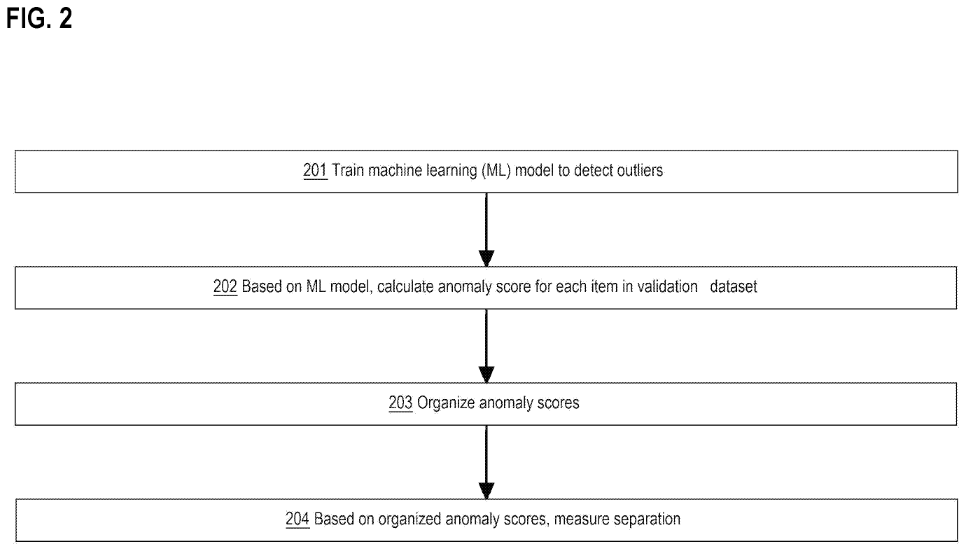

FIG. 2 is a flow diagram that depicts an example process that computer 100 may perform, based on probabilities or other statistics, to validate fitness of machine learning (ML) models such as 111-112 for binary classification such as outlier detection, during or after unsupervised training. FIG. 2 is discussed with reference to FIG. 1.

Steps 201-202 are preparatory and may be performed by computer 100 or a different computer. Step 201 trains ML model 111 to detect outliers. For example, a training corpus may contain some items that are outliers and many items that are normal. Example training procedures for example ML architectures are discussed later herein.

Step 202 validates the training accuracy of step 201. During validation in step 202, ML model 111 calculates a respective anomaly score for each item A-N in validation dataset 120. ML model 111 may be applied to one item at a time to generate a respective anomaly score during validation run X. In other words, step 202 performs run X.

Steps 203-204 analyze the validation results of step 202. Step 203 organizes the anomaly scores of items A-N. In an embodiment discussed earlier herein, step 203 organizes anomaly scores by numerically sorting them. In another embodiment and for reasons discussed later herein, step 203 instead organizes anomaly scores by clustering them, which may be more complicated than natural sorting.

Based on the organized anomaly scores, step 204 measures a quantitative separation between normal items as a group and outlier items as a group. As discussed later herein, separation may be calculated according to various formulae. For example when step 203 entails clustering, step 204 may analyze characteristics of, and relationships between, clusters to measure separation.

Although the process of FIG. 2 concludes with measuring separation, additional processing may occur that entails managing ML model 111 and/or 112 based on measured separation(s). For example as discussed earlier and later herein, measured separation may be used to terminate training an ML model or select a best or best few ML model(s) from many ML models.

Although training items and/or validation items A-N may be labeled, neither techniques herein nor steps 201-204 need labels. For example, training step 201 may be unsupervised. Likewise, neither techniques herein nor steps 201-204 need a predefined anomaly threshold. Indeed, anomaly score organizing step 203 and/or separation measuring step 204 may produce data that can be used to set an anomaly threshold as discussed later herein.

### 3.0 Measuring Fitness Based on Contamination Factor

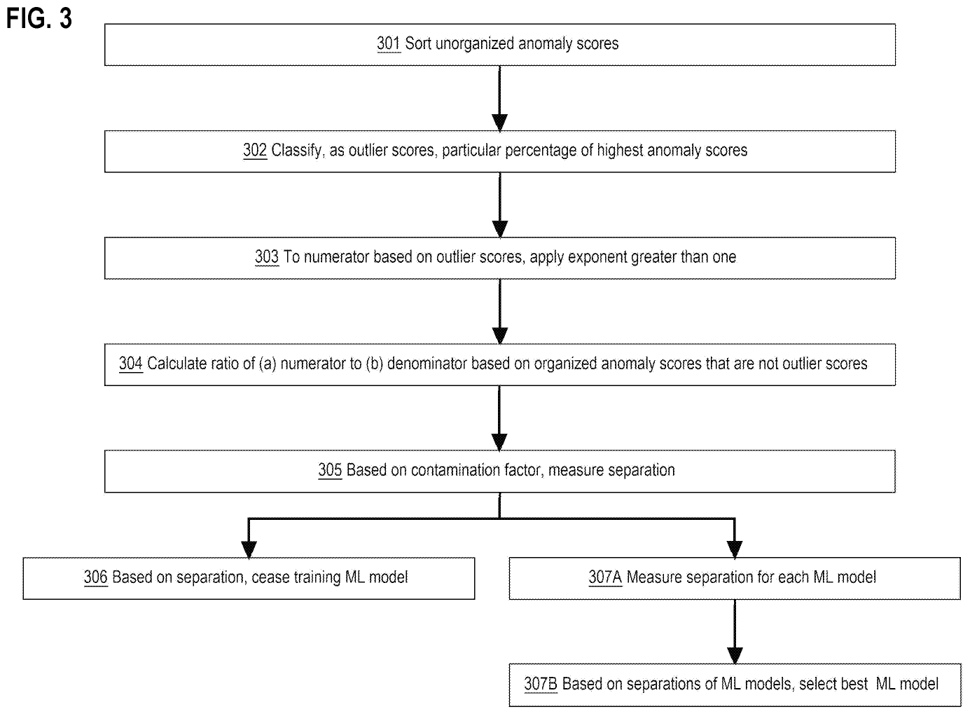

FIG. 3 is a flow diagram that depicts example activities that computer 100 may perform, based on probabilities or other statistics, to measure fitness of machine learning (ML) models such as 111-112 for binary classification such as outlier detection, during or after unsupervised training. FIG. 3 is discussed with reference to FIG. 1.

In step 301 unorganized anomaly scores from validation of ML model 111 are numerically sorted to be organized anomaly scores. Step 302 classifies, as outlier scores, a percentage of highest anomaly scores. For example, thirty percent of validation items A-N having highest anomaly scores in validation run X become classified as outliers because the contamination factor of validation dataset 120 is thirty percent.

Arithmetic steps 303-304 calculate intermediate quantities needed by step 305 for measuring separation in an embodiment. Elsewhere herein, other embodiments measure separation in other ways. Various embodiments of separation measurement are based solely or partly on ratio(s) of multiple metrics of the organized anomaly scores. A ratio may have a numerator and a denominator.

In an embodiment, separation is a ratio with a numerator that is an average, median, or mode of the outlier anomaly scores and a denominator that is an average, median, or mode of the normal anomaly scores. For example, the numerator may be an average, and the denominator may be a median. In an embodiment, the numerator is a minimum of the outlier anomaly scores, and/or the denominator is a maximum of the normal anomaly scores.

Above step 302 used a percentage of the sorted anomaly scores, such as a contamination factor, to distinguish between normal and outlier scores. For example, the highest thirty percent of anomaly scores may be outliers. In an embodiment, a lesser percent may identify a particular anomaly score within the outliers. For example, a particular outlier anomaly score may correspond to the tenth percentile of all anomaly scores. In that case, an embodiment may set an anomaly threshold as that particular outlier anomaly score.

In an embodiment the numerator is a particular outlier anomaly score in a particular percentile of all anomaly scores, and/or the denominator is a particular normal anomaly score in a complementary percentile of all anomaly scores, such that complementary means a subtractive difference of a hundred percent minus the particular percentile such as shown in the following example separation formula 1:

$$Separation = \frac{{x}^{th} Percentile Score of Anomalies}{{( 1 - x )}^{th} Percentile Score of Normals}$$

For example if the particular percentile is ten, then the complementary percentile is ninety. The particular percentile should be lower than the complementary percentile, but the anomaly score of the particular percentile should be higher than the anomaly score of the complementary percentile.

Separation can be exaggerated by magnifying the numerator. To a numerator based on outlier anomaly scores, step 303 applies an exponent greater than one for magnification such as in separation formula 2 below.

Step 304 calculates a ratio of (a) a numerator to (b) a denominator that is based on organized anomaly scores that are normal anomaly scores such as a maximum, mean, median, or mode of normal anomaly scores. Ratio step 304 may occur in separation formula 2-3 below.

Based on the contamination factor of validation dataset 120, step 305 measures separation between normals and outliers for validation run X. For example, any of above steps 302-304 may be based on the contamination factor, and any of those steps may provide an intermediate calculation that step 305 uses to calculate separation. Thus, separation measurement by step 305 may be indirectly based on the predefined contamination factor of validation dataset 120. In an embodiment, steps 303-305 occur as part of performing the following example separation formula 2:

$$Separation = \frac{{( Mean Score of Anomalies )}^{N}}{Median Score of Normals}$$

Together, steps 302 and 304-305 may instead measure separation in a different way such as according to the following example separation formula 3:

$$Separation = \frac{Min Score of Anomalie}{Max Score of Normals}$$

In an embodiment, step 305 incorporates techniques of quantile regression and measures an absolute deviation from a quantile (QUAD) family. The quantile corresponds exactly to an anomaly threshold that is based on the contamination factor as discussed above.

In any case, above steps 301-305 provide ways to measure separation. How separation is used after measurement depends on the use case. FIG. 3 depicts two separate use cases that may or may not be mutually exclusive. In one use case, step 306 occurs. In the other use case, steps 307A-B occur instead.

As explained earlier herein, training may be iterative such as with batches such that processing alternates between continued training and failed validation. Based on separation, step 306 ceases training ML model 111 such as when validation finally succeeds. In other words, separation is repeatedly measured, and each measurement determines whether to resume training or instead perform step 306 to halt training.

Usually, adequate separation is achieved before convergence of other accuracy measurements such as model loss or reconstruction error. In other words, based on adequate separation, training may halt sooner than with other convergence approaches. Thus, step 306 accelerates training such that training consumes less energy.

A different use case entails steps 307A-B. Step 307A measures separation for each of many ML models 111-112. For example, step 307A may measure separation of validation run X for ML model 111 and separation of run Y for ML model 112. As explained earlier herein, even though runs X-Y use same validation dataset 120, respective separations between normals and outliers may be different for runs X-Y.

Based on respective separations of many ML models 111-112, step 307B selects a best one or few ML model(s) for promotion such as further training or production deployment as discussed earlier herein. That is, step 307B may rank all ML models 111-112 by separation.

### 4.0 Fitness Metric Based on Clustering

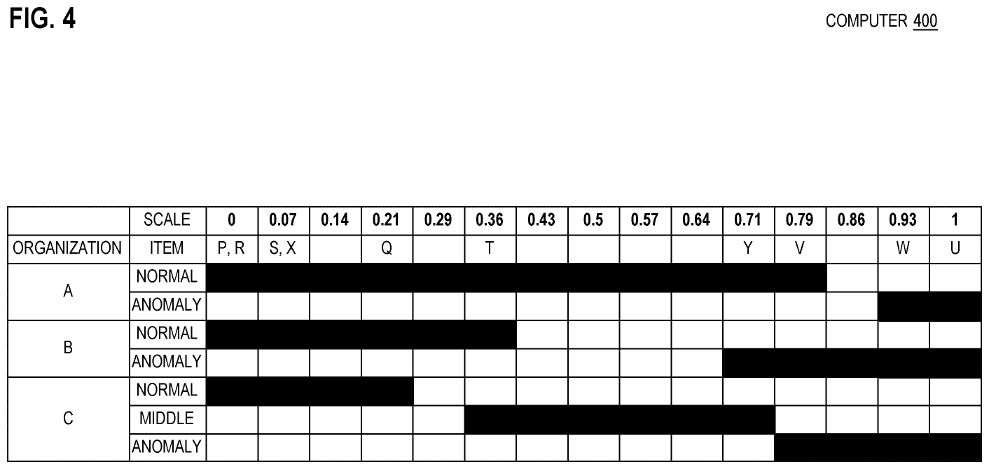

FIG. 4 is a block diagram that depicts an example computer 400, in an embodiment. Based on statistical clustering, computer 400 analyzes validation results of machine learning (ML) model(s) for binary classification such as outlier detection, during or after unsupervised training. Computer 400 may be an implementation of computer 100.

The chart in FIG. 4 shows data that computer 400 may generate, store, and/or analyze. Scale is shown as the top row of the chart. Scale is implied and not stored. Scale provides a range of possible anomaly scores that are normalized from zero to one. Normalized scores may be anomaly probabilities such that zero means certainly normal and one means certainly anomalous.

Item is shown as the second row of the chart. Entries in the item row indicate what approximately is the anomaly score of each item P-Y during validation. For example, items P and R have anomaly scores that are exactly or nearly zero. Thus, items P and R are certainly normal. Whereas item U is certainly abnormal.

Shown spacing of items P-Y is proportional to the anomaly scores of items P-Y. For example, items V and Y are shown near each other because they have similar anomaly scores. Likewise, items T and Y are shown far from each other because they have dissimilar anomaly scores.

Based on the distribution of the anomaly scores as reflected in their shown spacing, computer 400 may organize the anomaly scores into two or more clusters, where scores in a same cluster are similar, and scores in different clusters are dissimilar. Although the chart shows anomaly scores for only one validation run, due to various clustering criteria discussed later herein, the same validation set of anomaly scores may be reorganized into various different organizations such as A-C that have different amounts of clusters and/or different mappings of same items P-Y into clusters.

As shown, organizations A-B each have a respective normal cluster and an anomaly cluster. Organization C has a normal cluster, an anomaly cluster, and a middle cluster. Each cluster is shown as a horizontal black bar.

For example, the normal cluster of organization A contains anomaly scores of items P-T, V, and X-Y. The anomaly cluster of organization A contains anomaly scores of items U and W. As shown, item V occurs in the normal cluster of organization A but instead occurs in the anomaly cluster of organization B.

The reorganization of items P-Y into many alternative organizations A-C is demonstrative. That is, a practical embodiment of computer 400 has only one or two ways to perform clustering such that computer 400 is able to achieve only one or two of organizations A-C. So many organizations A-C are shown for demonstrative comparison.

The chart contains columns, and separation between a normal cluster and an anomaly cluster of a same organization may be visually estimated by counting how many empty columns separate the normal cluster from the anomaly cluster. For example, only one column separates the normal cluster and anomaly cluster of organization A. Whereas four columns separate the normal cluster and anomaly cluster of organization B. Thus, organization B has greater separation than organization A. Thus, organization B is better than organization A.

Likewise and although not shown, different validation runs for same or different ML models may have different separations, even when organized by a same clustering algorithm. Thus, different validation runs and/or different ML models may be ranked for model fitness based on respective separations of normal and anomaly clusters such as discussed later herein.

Organization C has a middle cluster that contains anomaly scores of items T, V, and Y. In other words, organization C is generated by a three-clustering algorithm. Whereas organizations A-B are generated by a two-clustering algorithm. Two-clustering and three-clustering are examples of K-clustering algorithms that organize data into a predefined K amount of clusters. For example, a three-clustering algorithm should always or almost always organize data into three clusters.

The middle cluster of organization C may contain anomaly scores of items that are somewhat ambiguous as to classification as normal or anomalous. For example, the middle cluster may indicate which and how many items are difficult for the ML model to classify. Thus, statistics of the middle cluster and relationships between the middle cluster and other clusters may indicate model fitness and may be factored into measuring separation between a normal cluster and an anomaly cluster as discussed later herein.

Informally, the middle cluster may represent an amount of fuzziness (i.e. inaccuracy) in the ML model. In a K-clustering embodiment where K is more than three, there may be multiple middle clusters. In any case in a given organization, clusters do not overlap. That is, the anomaly score of an item belongs to exactly one cluster, no matter how many clusters the organization has.

### 5.0 Cluster-Based Measuring Process

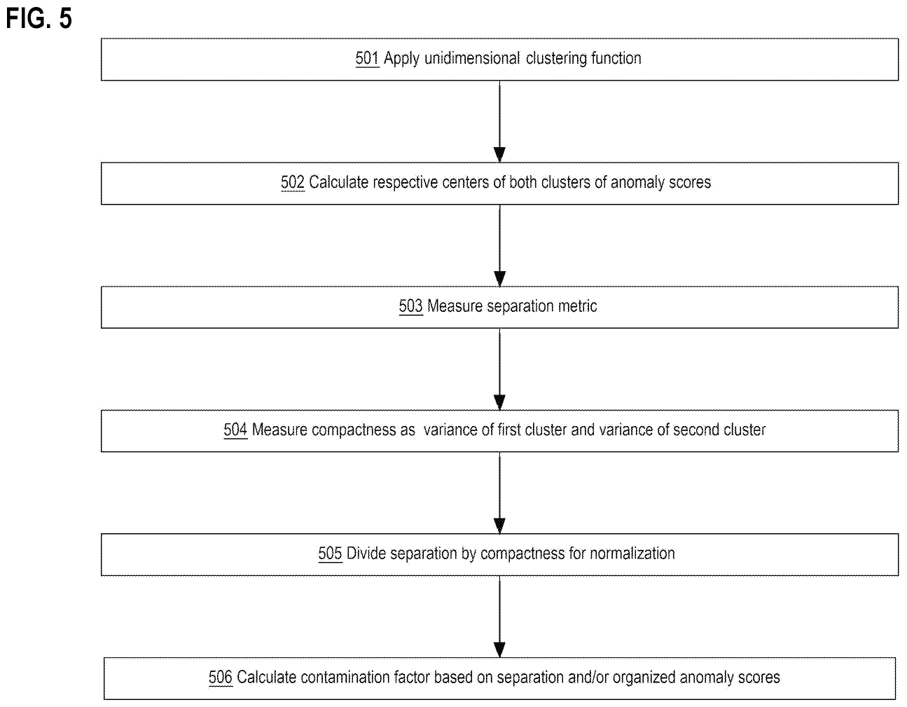

FIG. 5 is a flow diagram that depicts example activities that computer 400 may perform, based on clustering, to measure fitness of machine learning (ML) models for binary classification such as outlier detection, during or after unsupervised training. FIG. 5 is discussed with reference to FIG. 4.

The process of FIG. 5 presumes that validation already generated unorganized anomaly scores. The unorganized anomaly scores are clustered to be organized anomaly scores that includes at least a normal cluster and an anomaly cluster. For example, step 501 may apply a unidimensional clustering function to the unorganized anomaly scores. Here, unidimensional means that only the numeric anomaly scores are considered during clustering by step 501. The unidimensional clustering function may be a K-clustering function where K is at least two.

The respective centers of clusters may be important statistics for measuring separation between two clusters and especially between the normal cluster and the anomaly cluster although some embodiments may sometimes use a middle cluster as one of the two clusters for some calculations as discussed later herein. Step 502 calculates respective centers of at least the normal cluster and the anomaly cluster. Various ways of calculating the center of a cluster include the mean, median, or mode of the anomaly scores of the cluster.

In any case, a center is a scalar number. Which anomaly scores are in a cluster and what is the center of that cluster depend on which organization A-C contains the cluster. For example even though organizations A-B are based on same unorganized anomaly scores, organizations A-B have different respective centers of normal clusters and different respective centers of anomaly clusters.

In various embodiments, step 503 performs various calculations that may be used as terms in a cluster separation measurement formula. Herein, cluster separation is a reliable indicator of ML model fitness and may be used instead of other fitness metrics such as F1, recall, or precision. For example, other fitness metrics require training labels and are incompatible with unsupervised training, unlike step 503 that is training agnostic.

In an embodiment, step 503 measures fitness as a distance between the centers of two clusters such as according to the following example fitness formula 4:

fitness=Cluster Center of Anomalies−Cluster Center of Normals

In another embodiment, step 503 instead measures fitness as a distance between particular respective items in both clusters such as according to the following example fitness formula 5:

$$fitness = 95 th Percentile Point of Normal Samples - 5 th Percentile Point of Anomalous Samples$$

In an embodiment, step 503 calculates a ratio of the center of one cluster over the center of another cluster such as according to the following example fitness formula 5:

$$fitness = \frac{Cluster Center of Anomalies}{Cluster Center of Normals}$$

In an embodiment, step 503 measures an average margin of the organized anomaly scores. That is, each anomaly score has a margin, and a cluster or the set of all anomaly scores in all clusters may have an average margin. Various embodiments may use either of two kinds of margin.

An anomaly score may have a first distance to the center of the cluster that contains the anomaly score and a second distance to the center of the closest other cluster to the anomaly score. The first and second distances may be used to calculate relative margin or additive point margin. Relative margin is the ratio of the first distance over the second distance. The smaller this ratio is, the better organized is the clustering.

Additive point margin is an arithmetic difference of the second distance minus the first distance. In an embodiment, additive point margin is normalized by a compactness metric of the organized anomaly scores. Compactness is discussed below. Unlike relative margin, a higher number is better for additive point margin.

No matter which kind of margin is used, quantitative fitness of an ML model may be based on an average margin for all of the organized anomaly scores. Margins depend on which organization A-C is used. For example even though organizations A-B are based on same unorganized anomaly scores, organizations A-B have different respective average margins.

In various embodiments, step 504 perform various calculations that may be used as terms in a separation measurement formula. Various embodiments of step 504 provide different ways of measuring compactness of a cluster. Informally, compactness is somewhat akin to density, except that density has a specific formula, whereas compactness may be calculated in various ways as follows.

In an embodiment, step 504 measures compactness of the organized anomaly scores as average distance between each anomaly score and the center of whichever cluster contains the anomaly score. The variance of a cluster is the variance of the anomaly scores in the cluster. In an embodiment, step 504 measures compactness as an average variance of all clusters. In an embodiment, step 504 measures compactness as an average of distances between all pairings of anomaly scores in a same cluster, for all clusters. In an embodiment, step 504 uses a maximum instead of an average.

The following example fitness formula 6 uses one kind of compactness as a denominator:

$$fitness = \frac{\begin{matrix}Cluster Center of Anomalies - \\ Cluster Center of Normals\end{matrix}}{ \begin{matrix}Mean squared distance of \\ samples to their closest cluster center\end{matrix}}$$

The following example fitness formula 7 uses the same kind of compactness as a denominator:

$$fitness = \frac{\frac{Cluster Center of Anomalies}{Cluster Center of Normals}}{\begin{matrix}Mean squared distance of \\ samples to their closest cluster center\end{matrix}}$$

Step 505 divides any metric by compactness for normalization. For example, average margin of step 503 may be normalized by dividing by compactness.

FIGS. 1-3 provide techniques for using a predefined contamination factor of a validation dataset to measure fitness of an ML model. FIGS. 4-5 provide techniques for measuring fitness without a contamination factor, which is crucial when the contamination factor is unknown, in which case, optional step 506 could calculate the contamination factor based on measured separation and/or organized anomaly scores by the techniques of FIGS. 4-5. For example if the anomaly cluster contains five percent of the organized anomaly scores, the contamination factor is five percent.

### 6.0 Feature Suppression Process

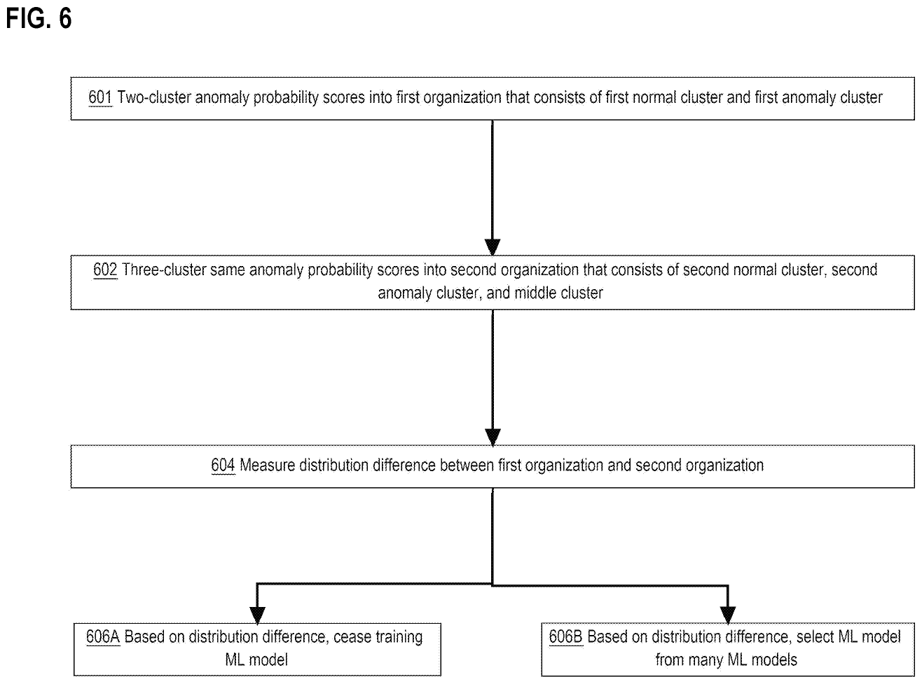

FIG. 6 is a flow diagram that depicts an example process that computer 400 may perform, based on three-clustering, to calculate a fitness metric of machine learning (ML) models for binary classification such as outlier detection, during or after unsupervised training. FIG. 6 is discussed with reference to FIG. 4, which depicts organizations A-C.

Step 601 performs a two-clustering of unorganized anomaly scores into organization A that consists of a first normal cluster and a first anomaly cluster. Step 602 reorganizes the same unorganized anomaly scores by performing a three-clustering of the unorganized anomaly scores into organization C that consists of a second normal cluster, a second anomaly cluster, and a middle cluster.

Step 604 measures a distribution difference between organizations A and C. Various embodiments measure difference in various respective ways such as follows. In an embodiment, cross entropy is a difference metric that is calculated as follows.

A statistical distribution (e.g. many coin tosses) has quantifiable entropy, which is predicted or observed randomness. Cross entropy is a quantifiable difference between two different probability distributions. For example, during respective validation runs using the same validation items, two different anomaly detectors may somewhat disagree as to which few items are anomalous.

That is, one anomaly detector imposes one statistical distribution onto the validation items, and the other anomaly detector imposes a different statistical distribution onto the same items. Cross entropy is a quantified difference between both statistical distributions. However, cross entropy is more complex than merely an arithmetic difference between respective quantified entropies of two different distributions.

For example and although not shown, with two different organizations of three anomaly scores, one organization may find two normal items and one anomalous item, and the other organization with the same anomaly scores may instead find two anomalies and one normal. Both validation runs have a same quantified entropy, but the cross entropy is not low. Likewise even if both organizations agree on how many items are anomalous, cross entropy is not low unless both organizations agree exactly which items are the anomalies.

In other words, cross entropy can measure disagreement between two alternative statistical distributions of the same items. For example, organizations A-B disagree on whether or not item V is an anomaly.

In an embodiment, an anomaly score is a statistical probability that an item is anomalous such that zero is certainly normal and one is certainly anomalous. There are various ways of calculating cross entropy between two organizations. One way to calculate cross entropy between organizations is based on polarization of the anomaly scores. For example for organization A, polarization maps all anomaly scores of items in the normal cluster to a same probability of zero and all anomaly scores of items in the anomaly cluster to a same probability of one. The same mapping can be done to organization C so that items P-Y are again polarized to zero or one.

However, organization C also has a middle cluster whose anomaly scores should all be mapped to a same polarized value, which depending on the embodiment could be zero or one. In other words, the middle cluster is merged with either the normal cluster or the anomaly cluster, depending on the embodiment.

In an embodiment, cross entropy between organizations A and C can be calculated based on the polarized values from both organizations A and C. In an embodiment, cross entropy is instead calculated based on the polarized values from organization C and the original anomaly scores of the validation run. In any case, standard implementations of information theory formulae such as cross entropy are available in Python libraries such as scikit-learn and Keras.

Thus in an embodiment, step 604 measures cross entropy between two-clustering organization A and three-clustering organization C. Because the middle cluster of organization C represents ambiguity as discussed earlier herein, the more items are in the middle cluster, the less reliable are the validation anomaly scores, and the higher is the cross entropy between organizations A and C, which is important as discussed below. In other embodiments, step 604 instead makes a different measurement that is somewhat similar to cross entropy such as any of:
logistic loss,
log loss,
Kullback-Leibler (KL) divergence, or
a percentage of anomaly scores that are in the middle cluster of organization C.

Steps 606A-B represent respective use cases. Based on the distribution difference of step 604 such as cross entropy, step 606A ceases training an ML model as discussed earlier herein. Based on the distribution difference of step 604 such as cross entropy, step 606B instead selects a best one or few ML model(s) from many ML models as discussed earlier herein.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

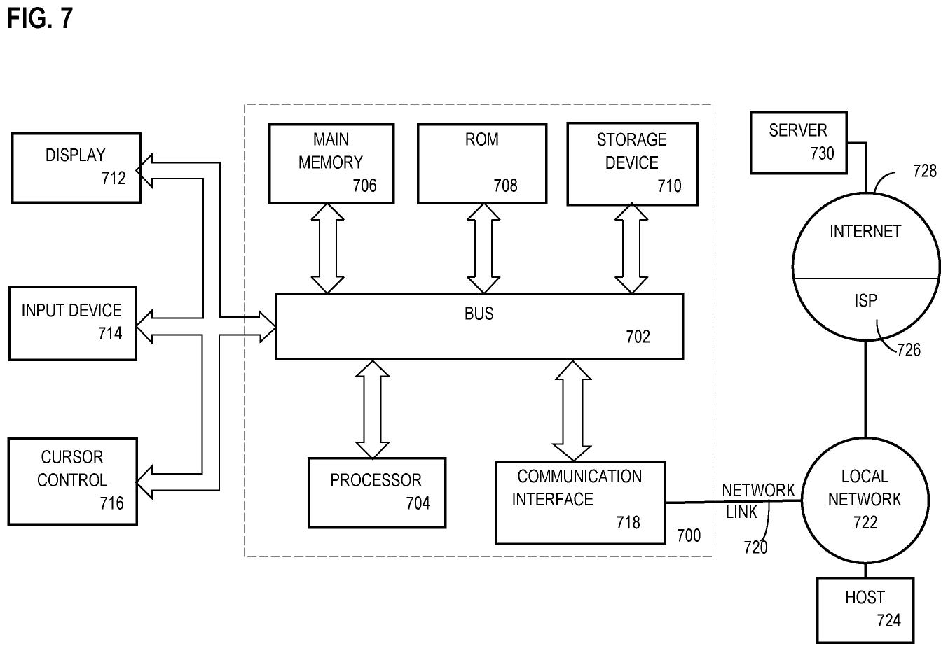

For example, FIG. 7 is a block diagram that illustrates a computer system 700 upon which an embodiment of the invention may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk, optical disk, or solid-state drive is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 710. Volatile media includes dynamic memory, such as main memory 706. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid-state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

### Software Overview

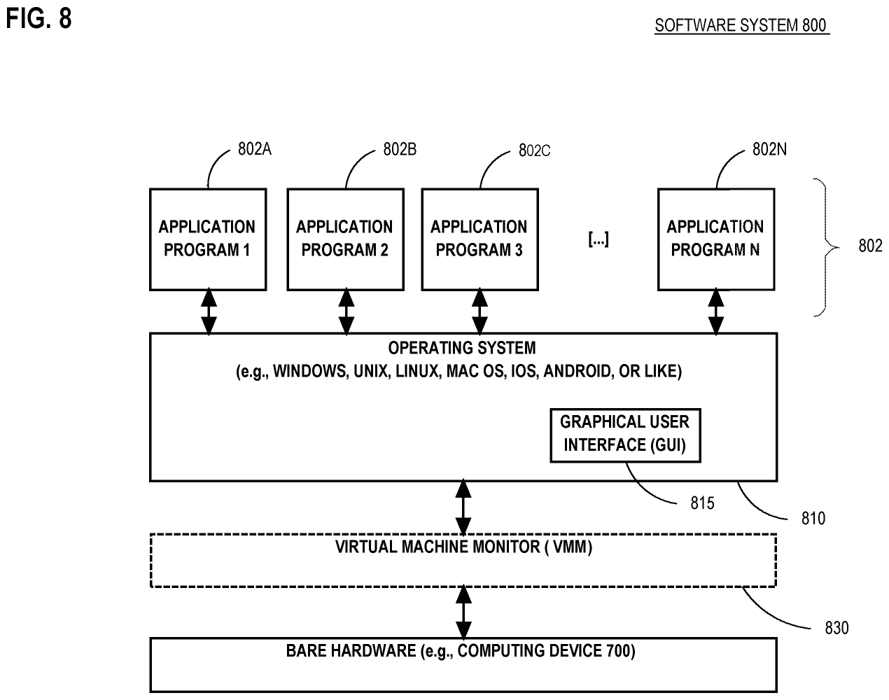

FIG. 8 is a block diagram of a basic software system 800 that may be employed for controlling the operation of computing system 700. Software system 800 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 800 is provided for directing the operation of computing system 700. Software system 800, which may be stored in system memory (RAM) 706 and on fixed storage (e.g., hard disk or flash memory) 710, includes a kernel or operating system (OS) 810.

The OS 810 manages low-level aspects of computer operation, including managing execution of processes, memory allocation, file input and output (I/O), and device I/O. One or more application programs, represented as 802A, 802B, 802C . . . 802N, may be “loaded” (e.g., transferred from fixed storage 710 into memory 706) for execution by the system 800. The applications or other software intended for use on computer system 700 may also be stored as a set of downloadable computer-executable instructions, for example, for downloading and installation from an Internet location (e.g., a Web server, an app store, or other online service).

Software system 800 includes a graphical user interface (GUI) 815, for receiving user commands and data in a graphical (e.g., “point-and-click” or “touch gesture”) fashion. These inputs, in turn, may be acted upon by the system 800 in accordance with instructions from operating system 810 and/or application(s) 802. The GUI 815 also serves to display the results of operation from the OS 810 and application(s) 802, whereupon the user may supply additional inputs or terminate the session (e.g., log off).

OS 810 can execute directly on the bare hardware 820 (e.g., processor(s) 704) of computer system 700. Alternatively, a hypervisor or virtual machine monitor (VMM) 830 may be interposed between the bare hardware 820 and the OS 810. In this configuration, VMM 830 acts as a software “cushion” or virtualization layer between the OS 810 and the bare hardware 820 of the computer system 700.

VMM 830 instantiates and runs one or more virtual machine instances (“guest machines”). Each guest machine comprises a “guest” operating system, such as OS 810, and one or more applications, such as application(s) 802, designed to execute on the guest operating system. The VMM 830 presents the guest operating systems with a virtual operating platform and manages the execution of the guest operating systems.

In some instances, the VMM 830 may allow a guest operating system to run as if it is running on the bare hardware 820 of computer system 700 directly. In these instances, the same version of the guest operating system configured to execute on the bare hardware 820 directly may also execute on VMM 830 without modification or reconfiguration. In other words, VMM 830 may provide full hardware and CPU virtualization to a guest operating system in some instances.

In other instances, a guest operating system may be specially designed or configured to execute on VMM 830 for efficiency. In these instances, the guest operating system is “aware” that it executes on a virtual machine monitor. In other words, VMM 830 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Machine Learning Models

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicated output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, executed, and/or as generating an output or predication, a computer system process executing a machine learning algorithm applies the model artifact against the input to generate a predicted output. A computer system process executes a machine learning algorithm by executing software configured to cause execution of the algorithm.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of best of breed machine learning algorithms may be found in open source libraries such as Google's TensorFlow for Python and C++ or Georgia Institute of Technology's MLPack for C++. Shogun is an open source C++ ML library with adapters for several programing languages including C#, Ruby, Lua, Java, MatLab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neuron.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of neurons in layer L−1 and L is N[L−1] and N[L], respectively, the dimensions of matrix W is N[L−1] columns and N[L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as vector. Training data comprises multiple inputs, each being referred to as sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Less neurons means less activation values need be computed, and/or less derivative values need be computed during training.

Properties of matrices used to implement a neural network correspond neurons and edges. A cell in a matrix W represents a particular edge from a neuron in layer L−1 to L. An activation neuron represents an activation function for the layer that includes the activation function. An activation neuron in layer L corresponds to a row of weights in a matrix W for the edges between layer L and L−1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptron (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occurs as explained above.

### Autoencoder

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas, unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction error is taught in non-patent literature (NPL) “VARIATIONAL AUTOENCODER BASED ANOMALY DETECTION USING RECONSTRUCTION PROBABILITY”, Special Lecture on IE. 2015 Dec. 27; 2(1):1-18 by Jinwon An et al.

### Principal Component Analysis

Principal component analysis (PCA) provides dimensionality reduction by leveraging and organizing mathematical correlation techniques such as normalization, covariance, eigenvectors, and eigenvalues. PCA incorporates aspects of feature selection by eliminating redundant features. PCA can be used for prediction. PCA can be used in conjunction with other ML algorithms.

### Random Forest

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature F2ootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include: number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
training a machine learning (ML) model to detect outliers;
calculating, based on the ML model, a respective anomaly score, of an unorganized plurality of anomaly scores, for each item in a validation dataset;
organizing the unorganized plurality of anomaly scores as an organized plurality of anomaly scores;
measuring, based on the organized plurality of anomaly scores, a separation;
wherein the method is performed by one or more computers.

2. The method of claim 1 wherein:
said validation dataset comprises a contamination factor;
said measuring the separation is further based on the contamination factor.

3. The method of claim 2 wherein:
the contamination factor indicates a particular percentage of said items in said validation dataset that are expected to be outliers;
said measuring said separation comprises:
classifying, as outlier scores, said particular percentage of highest anomaly scores of said organized plurality of anomaly scores, and
calculating a ratio of a numerator based on said outlier scores to a denominator based on said organized plurality of anomaly scores that are not said outlier scores.

4. The method of claim 3 wherein:
said numerator comprises an average of said outlier scores;
said denominator comprises a median of said organized plurality of anomaly scores that are not said outlier scores.

5. The method of claim 3 wherein:
said numerator exceeds one;
said calculating said ratio comprises applying, to said numerator, an exponent greater than one.

6. The method of claim 3 wherein:
said numerator comprises a minimum of said outlier scores;
said denominator comprises a maximum of said organized plurality of anomaly scores that are not said outlier scores.

7. The method of claim 3 wherein:
said numerator comprises a first particular percentile of said outlier scores;
said denominator comprises a second particular percentile of said organized plurality of anomaly scores that are not said outlier scores.

8. The method of claim 7 wherein said first particular percentile plus said second particular percentile sum to a hundred.

9. The method of claim 7 wherein said first particular percentile and said second particular percentile are based on said contamination factor.

10. The method of claim 2 further comprising:
measuring a respective separation, of a plurality of separations, for each particular ML model of a plurality of ML models based on:
a respective plurality of anomaly scores for said particular ML model, and same said contamination factor;
selecting, based on said plurality of separations, a best ML model of said plurality of ML models.

11. The method of claim 1 wherein said organizing the unorganized plurality of anomaly scores comprises an activity selected from the group consisting of:
sorting the unorganized plurality of anomaly scores, and
unidimensional clustering the unorganized plurality of anomaly scores.

12. The method of claim 11 wherein:
said organized plurality of anomaly scores comprises a first cluster of anomaly scores and a second cluster of anomaly scores;
said measuring said separation comprises calculating:
a first center of the first cluster of anomaly scores, and
a second center of the second cluster of anomaly scores.

13. The method of claim 12 wherein said measuring said separation further comprises calculating a metric selected from the group consisting of:
a distance between said first center of the first cluster of anomaly scores and said second center of the second cluster of anomaly scores,
a ratio of said first center of the first cluster of anomaly scores over said second center of the second cluster of anomaly scores, and
an average margin of said organized plurality of anomaly scores.

14. The method of claim 13 wherein said measuring said separation further comprises dividing said metric by a compactness.

15. The method of claim 14 wherein:
a statistic is selected from the group consisting of: average and maximum;
said compactness comprises said statistic applied to measurements selected from the group consisting of:
distances between (a) each anomaly score in a same cluster of said first cluster and said second cluster and (b) a center of said same cluster,
variance of the first cluster of anomaly scores and variance of the second cluster of anomaly scores, and
distances between all pairings of anomaly scores in a same cluster of said first cluster and said second cluster.

16. The method of claim 13 wherein said average margin comprises an average of margins selected from the group consisting of: relative margins and additive margins.

17. The method of claim 11 wherein said unidimensional clustering the unorganized plurality of anomaly scores comprises applying a unidimensional clustering function that has all of: scale invariance, consistency, richness, and perturbation invariance.

18. The method of claim 1 further comprising based on said separation, ceasing said training said ML model.

19. The method of claim 1 wherein said training said ML model comprises one selected from the group consisting of: unsupervised training, semi-supervised training, and weak supervised training.

20. The method of claim 1 further comprising calculating said contamination factor based on data selected from the group consisting of: said separation and said organized plurality of anomaly scores.

21. A method comprising:
two-clustering a plurality of anomaly scores into a first organization that consists of a first normal cluster of anomaly scores and a first anomaly cluster of anomaly scores, and
three-clustering same said plurality of anomaly scores into a second organization that consists of a second normal cluster of anomaly scores, a second anomaly cluster of anomaly scores, and a middle cluster of anomaly scores;
measuring a distribution difference between said first organization and said second organization;
processing, based on said distribution difference, a machine learning (ML) model;
wherein the method is performed by one or more computers.

22. The method of claim 21 wherein said processing said ML model based on said distribution difference comprises a reaction selected from the group consisting of:
ceasing training said ML model based on said distribution difference, and
selecting, based on said distribution difference, said ML model from a plurality of ML models.

23. The method of claim 21 wherein said distribution difference is selected from the group consisting of: cross entropy, logistic loss, log loss, Kullback-Leibler (KL) divergence, and a percentage of said plurality of anomaly scores that are in said middle cluster.

24. One or more non-transitory computer-readable media storing instructions that, when executed by one or more processors, cause:
training a machine learning (ML) model to detect outliers;
calculating, based on the ML model, a respective anomaly score, of an unorganized plurality of anomaly scores, for each item in a validation dataset;
organizing the unorganized plurality of anomaly scores as an organized plurality of anomaly scores;
measuring, based on the organized plurality of anomaly scores, a separation.

25. One or more non-transitory computer-readable media storing instructions that, when executed by one or more processors, cause:
two-clustering a plurality of anomaly scores into a first organization that consists of a first normal cluster of anomaly scores and a first anomaly cluster of anomaly scores, and
three-clustering same said plurality of anomaly scores into a second organization that consists of a second normal cluster of anomaly scores, a second anomaly cluster of anomaly scores, and a middle cluster of anomaly scores;
measuring a distribution difference between said first organization and said second organization;
processing, based on said distribution difference, a machine learning (ML) model.
